(19) United States
(12) Patent Application Publication
(10) Pub. No.: US 2016/0339721 A1
(43) Pub. Date: Nov. 24, 2016

(54) CARRIAGE APPARATUS, PRINTING APPARATUS, READING APPARATUS, AND WIRING STRUCTURE

(71) Applicant: CANON KABUSHIKI KAISHA, Tokyo (JP)

(72) Inventors: Ryoma Arai, Inagi-shi (JP); Takeshi Sekino, Yokohama-shi (JP); Daigo Kuronuma, Kawasaki-shi (JP)

(21) Appl. No.: 15/138,838

(22) Filed: Apr. 26, 2016

(30) Foreign Application Priority Data
May 22, 2015 (JP) 2015-104913

(51) Int. Cl. B41J 25/00; B41J 2/14

(52) U.S. Cl. CPC B41J 25/001; B41J 2/1433; B41J 2002/14491

(57) ABSTRACT

A carriage apparatus comprising: a carriage; a first and a second wiring bundle both connected to the carriage and follow the carriage; and a bendable sheet member sandwiched at least between the first and the second wiring bundle and follow the carriage, wherein the sheet member includes a first region and a second region positioned on a side of the carriage with respect to the first region, the rigidity of the second region is lower than that of the first region.

### BACKGROUND OF THE INVENTION

1. Field of the Invention

The present invention relates to a carriage apparatus, a printing apparatus, a reading apparatus, and a wiring structure.

2. Description of the Related Art

In a serial printing apparatus, a flexible flat cable (to be referred to as an FFC hereinafter) is used for electrical connection to a carriage. Along with full colorization and an increase in resolution of a printhead and an increase in print speed, the amount of electrical signals supplied to a droplet discharge unit, the discharge frequency, and the number of head pins have been increased. An increase in frequency increases the frequency of a driving signal to be enabled, and an increase in number of head pins increases the number of wiring patterns. If energization is performed by overlaying a plurality of FFCs into one, so-called crosstalk occurs in which noise caused by energization to another pattern is superimposed between patterns. If the crosstalk occurs, this does not cause an operation error but may shift an ink discharge timing or largely disturb a waveform to cause unstable ink discharge.

Japanese Patent Laid-Open No. 2007-207629 proposes a low-noise FFC by gripping the two sides of each conductor by insulating layers each formed by a porous sheet made of an olefin resin and an adhesive sheet made of an acid-modified olefin resin, and covering the outer surfaces of the conductors with shield tape.

The technique described in Japanese Patent Laid-Open No. 2007-207629 decreases noise by forming each insulating layer by a porous sheet made of an olefin resin and an adhesive sheet made of an acid-modified olefin resin in an FFC, and using air-filled portions of the porous sheet. At this time, to improve the bendability and slidability, the thickness of each insulating layer is set to 260 μm or less.

However, if stronger noise occurs, conductors may be spaced apart from each other by increasing the thickness of each insulating layer. In this case, the bendability and slidability may deteriorate, and the operation of a carriage may become unstable, thereby adversely affecting the print accuracy. Furthermore, an adhesive surface may peel off or become wrinkled due to a difference between the inner and outer radii in a bending region, thereby disconnecting the conductors.

### SUMMARY OF THE INVENTION

The present invention provides a technique of improving the bendability and slidability while preventing noise between wirings.

According to an aspect of the present invention, there is provided a carriage apparatus comprising: a carriage configured to reciprocate; a first wiring bundle connected to the carriage and configured to follow movement of the carriage; a second wiring bundle connected to the carriage and configured to follow the movement of the carriage; and a sheet member sandwiched at least between the first wiring bundle and the second wiring bundle and configured to be bendable to follow the movement of the carriage, wherein the sheet member includes a first region and a second region, the rigidity of the second region is lower than that of the first region, and the second region is positioned on a side of the carriage with respect to the first region.

According to still another aspect of the present invention, there is provided a carriage apparatus comprising: a carriage configured reciprocate; a first wiring bundle connected to the carriage and configured to follow movement of the carriage; a second wiring bundle connected to the carriage and configured to follow the movement of the carriage; and a sheet member sandwiched at least between the first wiring bundle and the second wiring bundle and configured to be bendable to follow the movement of the carriage, wherein the sheet member relatively moves with respect to at least one of the first wiring bundle and the second wiring bundle.

According to still another aspect of the present invention, there is provided a wiring structure comprising: a first wiring bundle connected to a carriage configured to reciprocate and configured to follow movement of the carriage; a second wiring bundle connected to the carriage and configured to follow the movement of the carriage; and a sheet member sandwiched at least between the first wiring bundle and the second wiring bundle and configured to be bendable to follow the movement of the carriage, wherein the sheet member includes a first region and a second region, the rigidity of the second region is lower than that of the first region, and the second region is positioned on a side of the carriage with respect to the first region.

According to still another aspect of the present invention, there is provided a wiring structure comprising: a first wiring bundle connected to a carriage configured to reciprocate and configured to follow movement of the carriage; a second wiring bundle connected to the carriage and configured to follow the movement of the carriage; and a sheet member sandwiched at least between the first wiring bundle and second wiring bundle and configured to be bendable to follow the movement of the carriage, wherein the sheet member relatively moves with respect to at least one of the first wiring bundle and second wiring bundle.

According to still another aspect of the present invention, there is provided a sheet member connected to a carriage configured to reciprocate, follows movement of the carriage and configured to be bendable, wherein the sheet member includes a first region and a second region, the rigidity of the second region is lower than that of the first region, and the second region is positioned on a side of the carriage with respect to the first region.

Further features of the present invention will become apparent from the following description of exemplary embodiments (with reference to the attached drawings).

### BRIEF DESCRIPTION OF THE DRAWINGS

FIG. 1 is a perspective view showing the overall arrangement of a printing apparatus according an embodiment of the present invention;

FIG. 2 is a perspective view showing the layout of flexible flat cables;

FIG. 3 is a sectional view taken along a ling A-A in FIG. 2;

FIG. 4 is a view obtained by excluding the flexible flat cables from the perspective view of FIG. 2;

FIG. 5 is a perspective view showing a sheet member;

FIG. 6 is a schematic view showing the laying state of the sheet member;

FIG. 7 is a view showing the first embodiment of the sheet member;

FIG. 8 is a view showing the second embodiment of the sheet member;

FIG. 9 is a view showing the third embodiment of the sheet member; and

FIG. 10 is a view showing the fourth embodiment of the sheet member.

### DESCRIPTION OF THE EMBODIMENTS

### Main Body Arrangement

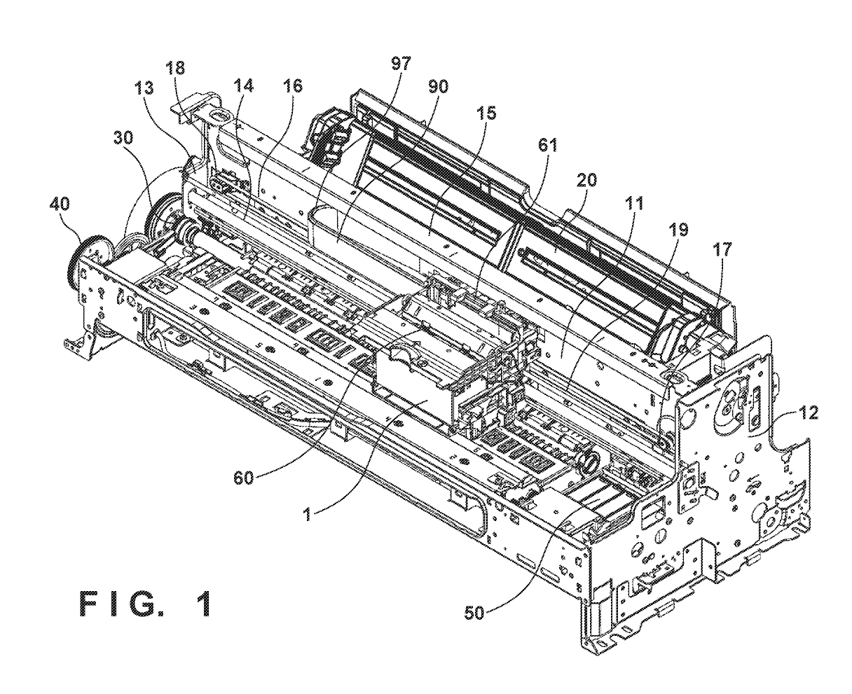

An exemplary embodiment of the present invention will be described below with reference to the accompanying drawings. The present invention will describe an embodiment of an inkjet printer as an example of a printing apparatus (print apparatus) including a carriage. The present invention is also applicable to a serial printer in addition to the inkjet printer. The present invention is not limited to the printing apparatus, and is applicable to a reading apparatus (scanner apparatus) in which a carriage moves while holding a reading head (reading unit). A carriage apparatus as an embodiment of the present invention will be described first with reference to FIGS. 1 to 4. Throughout the drawings, the same reference numerals denote the same elements. Throughout the drawings, the upward/downward and leftward/rightward directions with respect to a paper surface are used as the upward/downward and leftward/rightward directions of the apparatus according to this embodiment for the description.

FIG. 1 shows the overall inkjet print apparatus according to the embodiment of the present invention. This inkjet print apparatus prints by discharging ink from a printhead (printing unit) 1 mounted in a carriage movable along a sheet. Examples of the printhead 1 are a printhead, a head cartridge including a printhead, an inkjet pen, and a pen cartridge including an inkjet pen.

The inkjet print apparatus according to this embodiment is formed by a feeding unit 20, a conveyance unit 30, a discharge unit 40, a carrier unit 60 carrying the printhead 1, and a printhead recovery unit 50. The apparatus prints a sheet (printing medium) conveyed by the conveyance unit 30 from the feeding unit 20 by discharging ink from the printhead 1 of the carrier unit 60. The apparatus causes the conveyance unit 30 to discharge the printed sheet to the discharge unit 40. To prevent ink clogging of the printhead 1 before the start of printing or after the end of printing and the like, the printhead recovery unit 50 executes recovery processing for the printhead 1.

The feeding unit 20 serves as an ASF (Automatic Sheet Feeder) unit which pulls out print sheets one by one from a plurality of stacked sheets (print sheets), and feeds them to the conveyance unit 30. The conveyance unit 30 conveys the print sheet supplied from the feeding unit 20.

The carrier unit 60 includes a carriage 61 which reciprocates in a direction intersecting the conveyance direction of the print sheet (generally in a direction orthogonal to the conveyance direction) in synchronism with conveyance of the print sheet by the conveyance unit 30. More specifically, the carriage 61 is supported and guided by a guide shaft 14 fixed to a chassis 11 and a support rail 15 fixed onto the chassis 11. The driving force of the carriage motor 17 is transferred to the carriage 61 by a carriage belt 16 looped between a carriage motor 17 and an idle pulley 18, and the carriage 61 can then reciprocate (scan) along the guide shaft 14. The printhead 1 is mounted in the carriage 61. A CR encoder (not shown) for reading a code strip 19 attached to the chassis 11 is provided in the carriage 61.

A flexible flat cable (to be referred to as an FFC hereinafter) as a wiring bundle electrically connecting a control unit and the printhead 1 and obtained by arranging a plurality of signal lines to be flat is laid out in the carriage 61. The FFC transmits print information as an electrical signal from the control unit to the printhead 1. The detailed layout arrangement of the FFC will be described later.

If a host apparatus such as a computer (not shown) transmits print data and the control unit on a control substrate (not shown) stores the print data, the control unit issues a print operation start command to the inkjet print apparatus shown in FIG. 1. Then, a print operation starts.

Upon receiving the print operation start command, the inkjet print apparatus first performs a feeding operation. That is, the feeding unit 20 pulls out only one print sheet, and supplies it to the conveyance unit 30. The conveyance unit 30 conveys the print sheet until the print start position of the print sheet is set to a position facing the printhead 1 of the carrier unit 60.

While the print sheet is temporarily stopped, the carriage 61 is driven by the carriage motor 17 and the carriage belt 16 to scan (move) along the guide shaft 14 and the support rail 15. At this time, a signal of a head driver (not shown) is transmitted to the printhead 1 mounted in the carriage 61 via an FFC 90. In response to this signal, the printhead appropriately discharges an ink droplet to the print sheet. When the CR encoder (not shown) mounted in the carriage 61 reads the code strip 19 attached to the chassis 11, a timing at which the printhead 1 discharges an ink droplet to the print sheet is determined.

Upon end of printing for one line, the conveyance unit 30 conveys (feeds) the print sheet by a predetermined amount (predetermined line pitch). In this way, an operation of moving the carriage 61 and executing printing for one line by discharging ink from the printhead 1 while the print sheet is stopped and an operation of conveying the print sheet by the predetermined amount (predetermined line pitch) by the conveyance unit 30 are alternately repeated. This prints the entire surface of the print sheet. The conveyance unit 30 discharges, to the discharge unit 40, the print sheet whose entire surface has been printed.

<Layout Arrangement of Flexible Flat Cables>

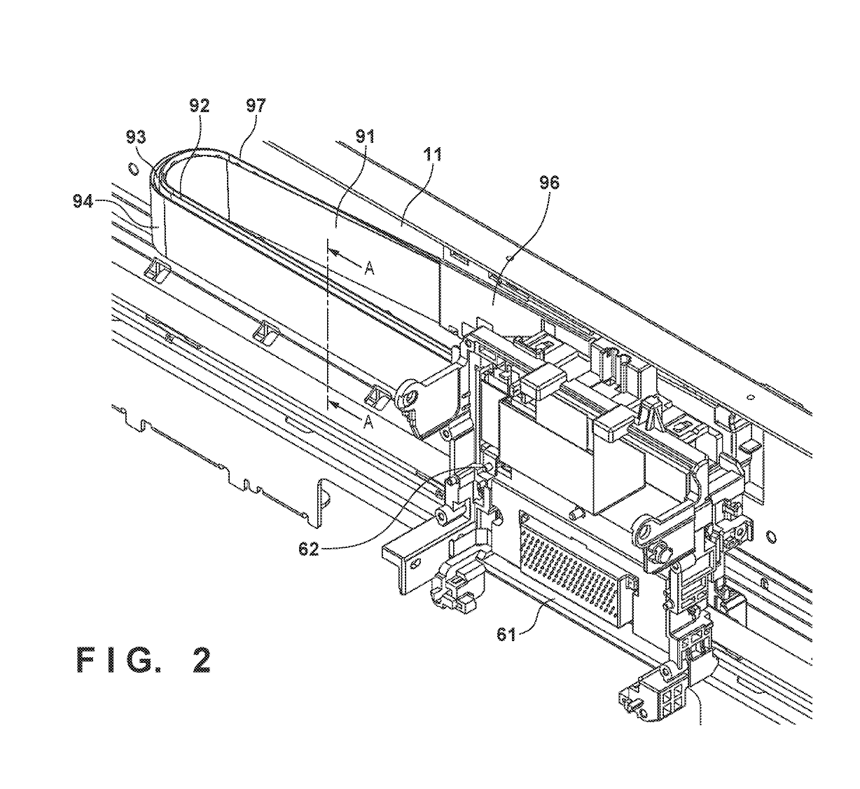

The layout arrangement of FFCs as the main feature of the print apparatus according to the present invention will be described in detail below. FIG. 2 is a perspective view showing the layout of the FFCs in the inkjet print apparatus shown in FIG. 1. As shown in FIG. 2, a plurality of (in this example, four) FFCs 91 to 94 are overlaid. These FFCs are laid out from the upstream side of the sheet conveyance direction to the downstream side of the sheet conveyance direction (from the upper right to the lower left in FIG. 2) through a hole formed in the chassis 11 along a surface, on the upstream side of the sheet conveyance direction, of the chassis 11 from the main board (not shown) of the print apparatus.

The FFCs 91 to 94 are fixed to the main body by a cable pressing member 96 which is attached to the chassis 11 near the midpoint of the carriage movement range on the downstream side of the sheet conveyance direction. The FFCs 91 to 94 are laid out along the same direction so as to form a loop (bending portion) bending at 180° between the cable pressing member 96 and a connector (not shown) on the substrate mounted in the carriage 61.

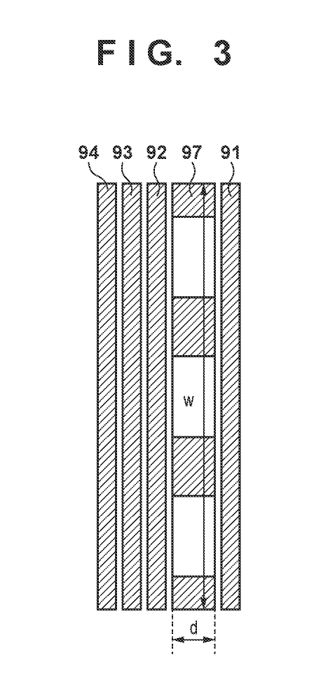

FIG. 3 is a sectional view showing the FFCs 91 to 94 when viewing the A-A section in FIG. 2 from the carriage side. A dummy bendable sheet member 97 (a belt-like a sheet member or a sheet material) having a predetermined thickness d and width w is disposed to be sandwiched between the FFC (first wiring bundle) 91 and the FFC (second wiring bundle) 92 which are adjacent to each other and are overlaid. Therefore, the FFCs 91 and 92 are always spaced apart by a distance longer than the distance d at any location. That is, the sheet member 97 serves as a spacer for giving a predetermined space or more between the FFCs to prevent crosstalk from occurring between signals of the adjacent FFCs.

To prevent crosstalk, the clearance between the two overlapping FFCs is preferably 0.5 mm or more. Therefore, the thickness d of the sheet member 97 can be set to a value of 0.5 mm or more, at least a value of 0.3 mm or more. Note that if the sheet member 97 is too thick, the elastic force increases to make it difficult to bend, the thickness d is preferably set to a value of 1 mm or less. The sheet member 97 is desired to have good balance between a role as a spacer and appropriate flexibility. In consideration of the tradeoff, the thickness is appropriately set. As the member of the sheet member 97, a member having a low dielectric property can be adopted in terms of prevention of crosstalk. For example, a resin member such as PET can be adopted. In this embodiment, the member of the sheet member 97 is a resin member (PET), the thickness d is 0.5 mm, and the width w is 25 mm almost equal to the width of the FFC. These numerical values are merely examples, and the maximum thickness d can be appropriately set within a range of 0.3 mm to 1 mm.

The sheet member 97 is disposed to be sandwiched between the FFCs 91 and 92, thereby forming a wiring structure. However, the sheet member 97 can be disposed at any location where crosstalk may occur. For example, the sheet member 97 can be arranged between the FFCs 92 and 93. Since the FFCs 91 to 94 are all held by the cable pressing member 96, the sheet member 97 can be disposed at least from the cable pressing member 96 to the carriage 61. In the FFCs 91 to 94 from the main board to the cable pressing member 96, the sheet member 97 need not be disposed near the main board as long as the FFCs 91 and 92 are always spaced apart by the predetermined distance d.

In a region (second region) which bends by following the carriage 61, one end of the sheet member 97 is held by the cable pressing member 96 of the main body in the middle of the movement range of the carriage 61 and the other end of the sheet member 97 is held by the carriage 61. One end of a region of the sheet member 97, which does not bend, is continuous from one end of the bending region, and held in the main body by the cable pressing member 96. The sheet member 97 is not directly adhered to the FFCs 91 to 94, which can prevent disconnection of conductors caused when the FFC peels off or becomes wrinkled due to a difference between the inner and outer radii in the region which bends by following the carriage 61. That is, the sheet member 97 can relatively move with respect to at least one of the FFCs 91 and 92.

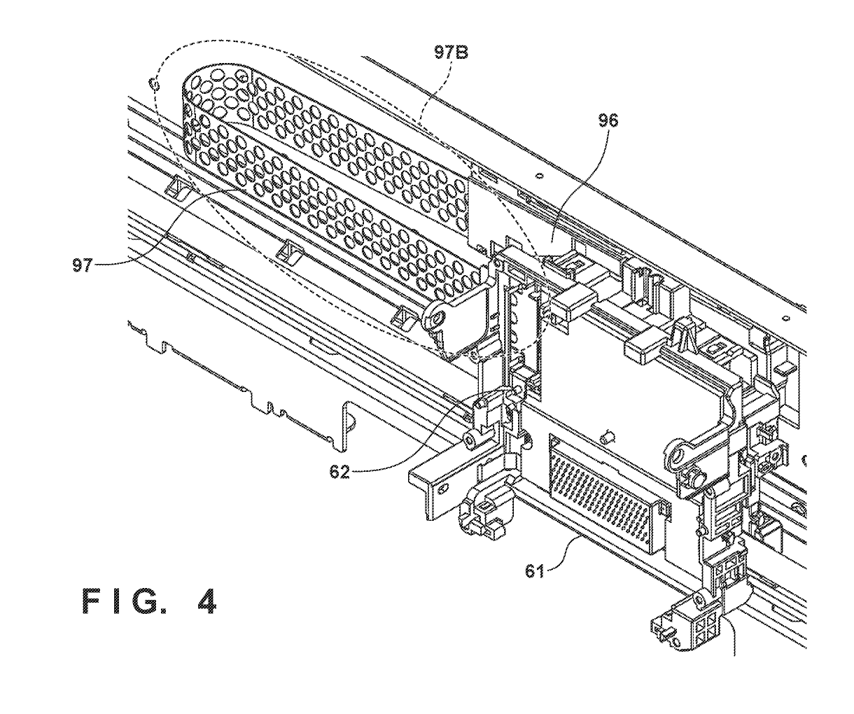

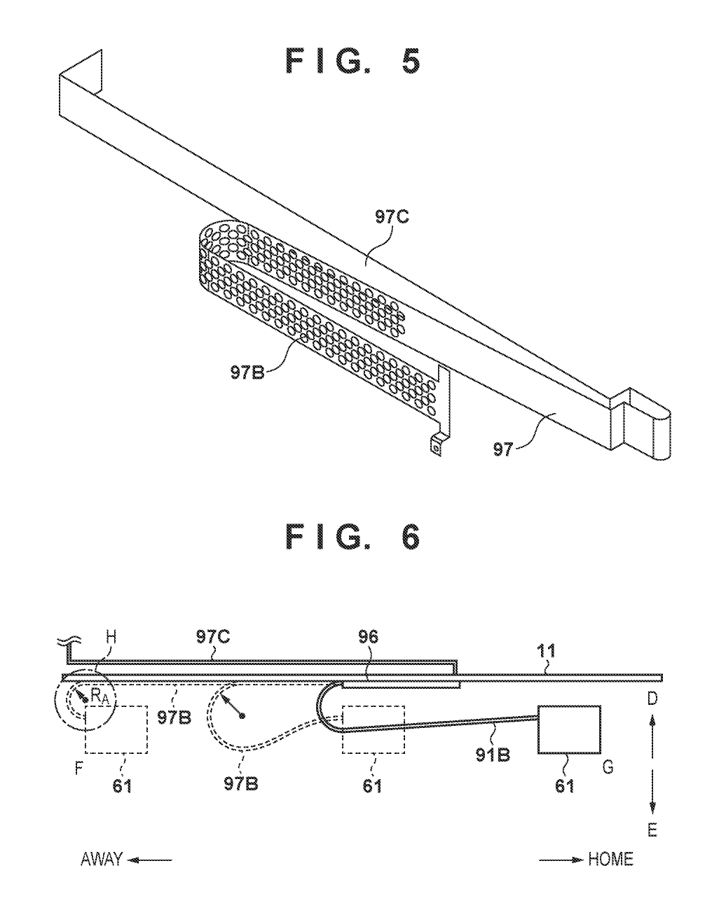

FIG. 4 is a view obtained by excluding the FFCs 91 to 94 from the perspective view of FIG. 2. The sheet member 97 is disposed to form a loop (bending portion) between the cable pressing member 96 and a sheet member attaching portion 62 in the carriage 61, similarly to the FFCs 91 to 94. As the position of the carriage 61 changes, the position of one end of the sheet member 97 connected to the sheet member attaching portion 62 changes, and the bending portion and a bend radius change. Reference numeral 97B denotes a bending region which is surrounded by a dashed line in FIG. 4. FIG. 5 is a perspective view showing only the sheet member 97. This region 97B is a region positioned on the side of the carriage 61 with respect to the cable pressing member 96. A remaining region (first region) 97C is a region on the main board side (not shown) with respect to the cable pressing member 96. Since this region is held by a member fixed to the main body of the print apparatus, there is no bending movement by a scan of the carriage.

FIG. 6 shows the laying state of the sheet member. In the region 97B where the bend radius changes along with the scan (movement in the horizontal direction in FIG. 6) of the carriage 61, a restoring force acts on the sheet member 97 in the feeding unit side direction (the direction of an arrow D in FIG. 6) or the discharge unit side direction (the direction of an arrow E in FIG. 6). For example, in the example shown in FIG. 6, if the carriage 61 scans from a position on the HOME side to a position on the AWAY side, a restoring force acts on the sheet member 97 in the feeding unit side direction (D direction). If the carriage 61 scans in the opposite direction, a restoration force acts in the discharge unit side direction (E direction) and the deformed sheet member 97 attempts to return to the original position by elasticity. Thus, the bend radius change region 97B of the sheet member 97 vibrates in the feeding unit side direction and the discharge unit side direction. If the sheet member 97 vibrates in this way, the load at the time of the scan of the carriage 61 may change, thereby degrading the print accuracy.

When the carriage 61 comes to a position closest to the AWAY side, it moves to a location indicated by F in FIG. 6. At this time, the loop shape of the sheet member 97 becomes a shape indicated by a region (third region) H surrounded by a one-dot dashed line in FIG. 6. In this case, the sheet member 97 has a minimum bend radius RA, and the restoring force acting from the sheet member 97 on the carriage 61 becomes largest. It is impossible to maintain the minimum bend radius RA depending on the thickness d of the sheet member 97. This may undesirably fold the sheet member 97, thereby causing damage to the FFC. To cope with this, it is necessary to decrease the rigidity at least in the region H in which the minimum bend radius RA is obtained.

The present invention has as its feature that at least the bending rigidity (which is also called bend rigidity or elastic force) in the region H, where the minimum bend radius RA is obtained, within the region 97B where the bend radius of the sheet member 97 changes is made smaller than that of the region 97C which is fixed to the main body of the print apparatus and in which there is no bending movement. This can reduce a reaction force by the sheet member 97, thereby maintaining the print accuracy and preventing the sheet member 97 from folding.

### First Embodiment

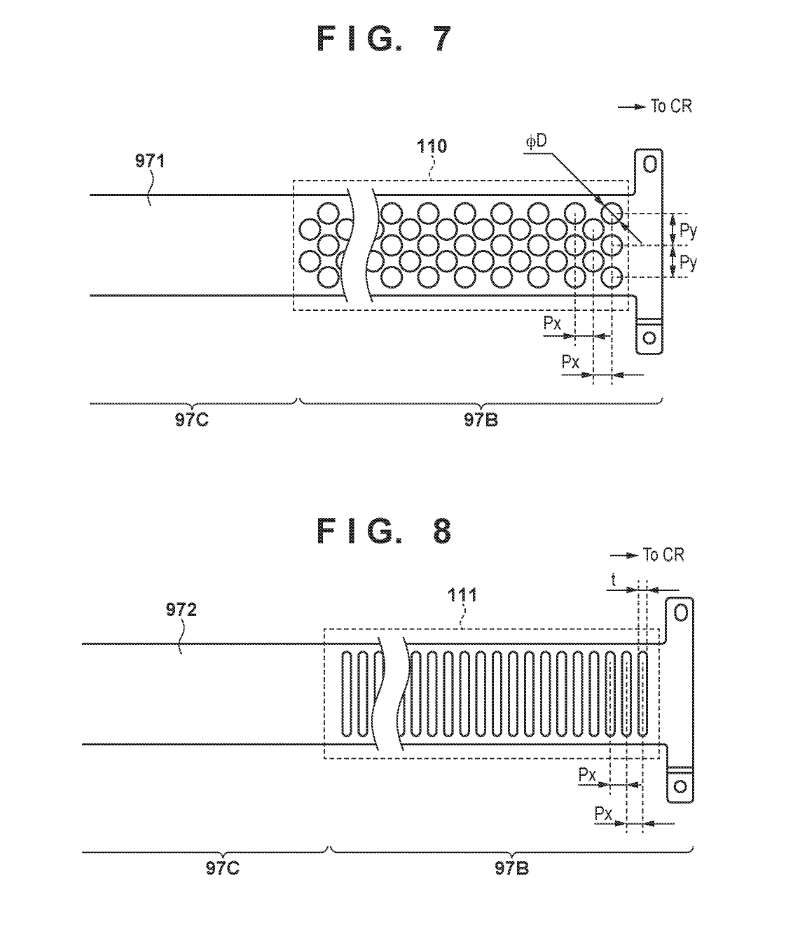

FIG. 7 shows part of a sheet member 971 according to the first embodiment. In this embodiment, to decrease the rigidity of the sheet member 971, a round hole shape group 110 having a staggered arrangement (zigzag arrangement) is included not only in a region H where a minimum bend radius RA is obtained but also in an entire region 97B where the bend radius changes. The round hole shape group 110 having the staggered arrangement is arranged from a portion overlapping a cable pressing member 96 to a carriage 61. Note that round holes are adopted to reduce stress concentration when the sheet bends but holes having another shape like a polygon such as a hexagon or octagon can be adopted.

For the round hole shape group 110 having the staggered arrangement, for example, a diameter φD of each hole, a pitch Px in the carriage main scanning direction (horizontal direction in FIG. 7), and a pitch Py in a direction (vertical direction in FIG. 7) orthogonal to the carriage main scanning direction can be set to 5 mm, 4.5 mm, and 9 mm, respectively. The round hole shape group 110 having the staggered arrangement decreases the bending rigidity in the bend radius change region 97B of the sheet member 971. It is possible to maintain the print accuracy by reducing the scanning load on the carriage 61.

Note that no round hole need be formed in a region 97C where there is no bending movement even if the carriage 61 scans. In the region 97C which does not bend, the sheet member 971 may be disposed in tight contact with FFCs 91 and 92, and a hole shape group is not necessary to reliably provide a clearance for prevention of crosstalk.

According to the above embodiment, using the sheet member 971 having an arbitrary thickness d can prevent crosstalk between the FFCs. Furthermore, since an arrangement in which the FFCs are adhered is not adopted, the sheet member 971 can relatively move, and disconnection of conductors caused by peeling or a wrinkle can be prevented. The round hole shape group 110 having the staggered arrangement is provided in at least the region H, where the minimum bend radius RA is obtained, within the region 97B where the bend radius of the sheet member 971 changes. Thus, the load for the scan of a carrier unit 60 (carriage 61) can be reduced, and it is possible to implement an inkjet print apparatus with high print accuracy by a simple arrangement.

One FFC (FFC (first wiring bundle) 91) is arranged on the inner diameter side of a bending when viewed from the sheet member 971. A plurality of (in this example, three) FFCs (the FFC (second wiring bundle) 92, an FFC (third wiring bundle) 93, an FFC 94) are arranged adjacent to each other on the outer diameter side of the bending when viewed from the sheet member 971. Since the FFC arranged on the outer diameter side has a larger bend radius, and has a smaller force for returning to the original position by an elastic force, it is rational to increase the number of FFCs on the outer diameter side, as compared with that on the inner diameter side. Note that a sheet member may be sandwiched between two FFCs arranged adjacent to each other.

### Second Embodiment

FIG. 8 shows part of a sheet member 972 according to the second embodiment. In this embodiment, the sheet member 972 includes a slit shape group 111 to decrease the rigidity in a region 97B where a bend radius changes. The slit shape group 111 has an arrangement in which a plurality of slits extending in the width direction (vertical direction in FIG. 8) of the sheet member 972 are arranged in the longitudinal direction (horizontal direction in FIG. 8) of the sheet member 972. In the slit shape group 111, for example, a slit width t is 2 mm and a pitch Px in the carriage main scanning direction is 4 mm. Note that the slit shape group 111 may adopt an arrangement in which a plurality of slits inclining with respect to the carriage main scanning direction are arranged. This decreases the bending rigidity in the bend radius change region 97B of the sheet member 972, and it is possible to maintain the print accuracy by reducing the scanning load on a carriage 61.

### Third Embodiment

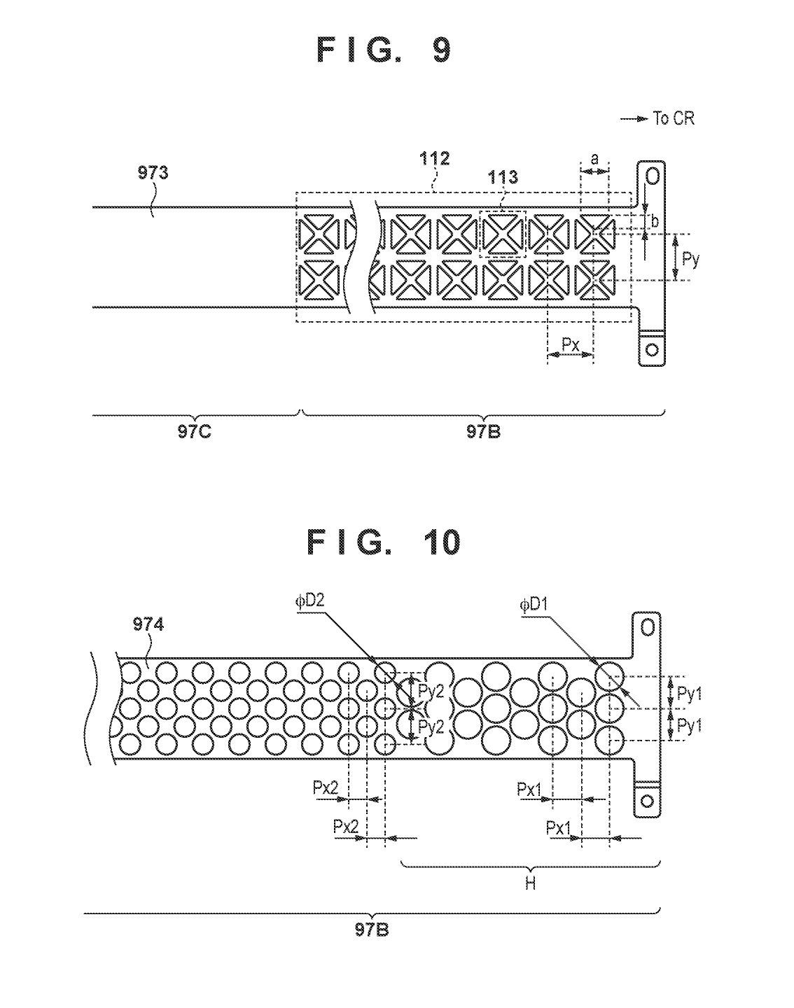

FIG. 9 shows part of a sheet member 973 according to the third embodiment. In this embodiment, to decrease the rigidity in a region 97B where a bend radius changes, the sheet member 973 includes a mesh shape group 112 in which holes are arranged in a mesh shape. The mesh shape group 112 can adopt an arrangement in which sets each including two mesh shapes 113 arrayed in a direction orthogonal to the carriage main scanning direction are arranged in the carriage main scanning direction. At this time, the plurality of mesh shapes 113 are arranged in the carriage main scanning direction at a predetermined pitch Px and in the direction orthogonal to the carriage main scanning direction at a predetermined pitch Py. The pitches Px and Py are arbitrarily set.

Each mesh shape 113 can adopt a rectangular hole shape obtained by arranging four triangular holes, each having a base a and a height b, adjacent to each other and leaving diagonal lines as a whole. The base a and height b are arbitrarily set. Note that the mesh shape is not limited to the above one, and rhomboid holes or the like may be adopted instead of the triangular holes. This decreases the bending rigidity in the region 97B where the bend radius of the sheet member 973 changes, and it is possible to maintain the print accuracy by reducing the scanning load on a carriage 61.

### Fourth Embodiment

FIG. 10 shows part of a sheet member 974 according to the fourth embodiment. In this embodiment, in a minimum bend radius region H, the size of each hole of a round hole shape group 110 having a staggered arrangement is larger than that in a remaining region 97B. As an example, a diameter φD1 of each hole, a pitch Px1 in the carriage main scanning direction, and a pitch Py1 in a direction orthogonal to the carriage main scanning direction can be set to 7 mm, 7 mm, and 7.95 mm, respectively. Note that in the bend radius change region 97B except for the minimum bend radius region H, the same shape as in the first embodiment is adopted. That is, a diameter φD2 of each hole, a pitch Px2 in the carriage main scanning direction, and a pitch Py2 in the direction orthogonal to the carriage main scanning direction can be set to 5 mm, 4.5 mm, and 9 mm, respectively.

In this embodiment, the rigidity of the region 97B where the bend radius of the sheet member 974 changes is set lower than that of a region 97C which does not bend, and the rigidity of the minimum bend radius region H is set lower than that of the region 97B. By changing the shape of each hole along with a change in bend radius in this way, each region can have appropriate rigidity. For example, the more a bend radius of the sheet member is small, the rigidity of the second region is able to set smaller.

As described above, in consideration of a minimum bend radius RA of the region H and the thickness of the sheet member 974, it is possible to change the round hole shape group 110 having the staggered arrangement of the minimum bend radius region H. As a method of decreasing the rigidity of the region H of the sheet member 974 where the minimum bend radius RA is obtained, the diameter of the round hole shape group 110 may be increased or the number of round hole shape groups 110 may be increased. This is applicable to not only the round hole shape but also to the slit shape according to the second embodiment and the mesh shape according to the third embodiment.

According to the above embodiment, the rigidity is changed by changing the number, shape, size, and density of holes along with a change in bend radius of the sheet member 974 depending on the scan position of a carriage 61. Similarly to the effects obtained by the sheet members 971 to 973 according to the first, second, and third embodiments, it is possible to ensure the minimum bend radius RA by further decreasing the rigidity in the minimum bend radius region H.

Note that each of the above embodiments has exemplified holes penetrating the sheet member in the thickness direction to decrease the rigidity. However, it is also possible to decrease the rigidity of the sheet member by adopting a thin portion in which the thickness of the sheet member is partially decreased. At this time, as the thin portion, a circular, elliptic, or polygonal concave portion in a planar view, a linear or curved groove extending in a predetermined direction such as the carriage main scanning direction, or the like can be exemplified. The thin portion may be formed on one or two surfaces of the sheet member. The plurality of exemplified shapes of the holes and those of the thin portion may be respectively used in combination. Furthermore, the present invention is applicable to an apparatus which needs to read a document, for example, a facsimile or copying machine as an image reading apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-104913, filed May 22, 2015, which is hereby incorporated by reference herein in its entirety.

What is claimed is:

1. A carriage apparatus comprising:
a carriage configured to reciprocate;
a first wiring bundle connected to the carriage and configured to follow movement of the carriage;
a second wiring bundle connected to the carriage and configured to follow the movement of the carriage; and
a sheet member sandwiched at least between the first wiring bundle and the second wiring bundle and configured to be bendable to follow the movement of the carriage,
wherein the sheet member includes a first region and a second region, the rigidity of the second region is lower than that of the first region, and
the second region is positioned on a side of the carriage with respect to the first region.

2. The apparatus according to claim 1, wherein
the first region is a region which does not be bent by the movement of the carriage, and
the second region is a region which is bent by the movement of the carriage.

3. The apparatus according to claim 2, wherein
the sheet member relatively moves with respect to at least one of the first wiring bundle and the second wiring bundle.

4. The apparatus according to claim 1, wherein
the more a bend radius of the sheet member small, the rigidity of the second region is set smaller.

5. The apparatus according to claim 1, wherein
the second region includes a third region where a bend radius is minimum, and
the rigidity of the third region is made smallest as the rigidity of the second region.

6. The apparatus according to claim 1, wherein
holes penetrating the sheet member in a thickness direction thereof are formed in at least one of the regions.

7. The apparatus according to claim 6, wherein
the holes are formed by at least one or two combinations of a group of a plurality of holes having a staggered arrangement, a group of a plurality of slits, and a group of holes formed in a mesh shape.

8. The apparatus according to claim 6, wherein
the rigidity of the sheet member is changed by changing a density of the holes with respect to the sheet member.

9. The apparatus according to claim 1, wherein
the sheet member includes a thin portion with a small thickness so as to change the rigidity thereof.

10. The apparatus according to claim 9, wherein
the thin portion includes a concave portion formed on one surface of the sheet member or both surfaces of the sheet member.

11. A carriage apparatus comprising:
a carriage configured to reciprocate;
a first wiring bundle connected to the carriage and configured to follow movement of the carriage;
a second wiring bundle connected to the carriage and configured to follow the movement of the carriage; and
a sheet member sandwiched at least between the first wiring bundle and the second wiring bundle and configured to be bendable to follow the movement of the carriage,
wherein the sheet member relatively moves with respect to at least one of the first wiring bundle and the second wiring bundle.

12. The apparatus according to claim 1, wherein
the sheet member is formed by a resin member whose maximum thickness falls within a range of 0.3 mm to 1 mm.

13. The apparatus according to claim 1, wherein
the second region includes a region held in the carriage, and
the first region includes a region held in a main body in the middle of a moving range of the carriage.

14. The apparatus according to claim 1, wherein
the first wiring bundle is arranged on an inner diameter side of a bending with respect to the sheet member,
the second wiring bundle is arranged on an outer diameter side of the bending with respect to the sheet member, and
a third wiring bundle is arranged adjacent to the outer diameter side of the second wiring bundle.

15. A printing apparatus comprising:
a carriage apparatus defined in claim 1; and
a printing unit mounted in the carriage.

16. A reading apparatus comprising:
a carriage apparatus defined in claim 1; and
a reading unit mounted in the carriage.

17. A wiring structure comprising:
a first wiring bundle connected to a carriage configured to reciprocate and configured to follow movement of the carriage;
a second wiring bundle connected to the carriage and configured to follow movement of the carriage; and
a sheet member sandwiched at least between the first wiring bundle and the second wiring bundle and configured to be bendable to follow the movement of the carriage,
wherein the sheet member includes a first region and a second region, the rigidity of the second region is lower than that of the first region, and
the second region is positioned on a side of the carriage with respect to the first region.

18. A wiring structure comprising:
a first wiring bundle connected to a carriage configured to reciprocate and configured to follow movement of the carriage;
a second wiring bundle connected to the carriage and configured to follow the movement of the carriage; and
a sheet member sandwiched at least between the first wiring bundle and second wiring bundle and configured to be bendable to follow the movement of the carriage,
wherein the sheet member relatively moves with respect to at least one of the first wiring bundle and second wiring bundle.

19. A sheet member connected to a carriage configured to reciprocate, follows movement of the carriage and configured to be bendable, wherein
the sheet member includes a first region and a second region, the rigidity of the second region is lower than that of the first region, and
the second region is positioned on a side of the carriage with respect to the first region.
